(19) United States
(12) Patent Application Publication
(10) Pub. No.: US 2004/0223682 A1
(43) Pub. Date: Nov. 11, 2004

(54) Hybrid optical circuits with thin film filters

(76) Inventors: Yi Ding, Milpitas, CA (US); Anders Grunnet-Jepsen, San Jose, CA (US); Mahmood Toofan, Milpitas, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/430,559

(22) Filed: May 6, 2003

(51) Int. Cl. G02B 6/12; G02B 6/26; G02B 6/10

(52) U.S. Cl. 385/14; 385/15; 385/130

(57) ABSTRACT

A planar light wave circuit may have thin film filters integrated into the planar light circuit. Waveguides formed in the planar light wave circuit may convey light transmitted from and reflected by the thin film filters. A variety of optical devices may be formed with the hybrid technology.

### BACKGROUND This invention relates generally to optical communications systems.

Many optical communication systems use wavelength division multiplexing. In wavelength division multiplexing a plurality of different signals of different wavelengths are multiplexed over a single light path. At their intended destination, the desired signals may be demultiplexed and split off from the rest of the optical communication link.

Wavelength division multiplexed networks commonly use either thin film filters or planar waveguide circuits. Thin film filters are known for their high performance in lower channel count applications. Planar light circuits are stronger in higher channel counts with a high degree of integration.

For example, both thin film filters and planar light circuits may be utilized to form optical multiplexers or demultiplexers in wavelength division multiplexed optical networks. Generally, at channel counts below 16, thin film filters are utilized. Above 16 channels, planar light circuits with arrayed waveguide gratings dominate due to their higher level of integration and parallel processing capability.

In contrast, in a 4 channel coarse wavelength division multiplexed transceiver, a thin film filter implemented multiplexer/demultiplexer may have better performance than that of an arrayed waveguide. However, the thin film filter may be difficult to integrate with planar light circuits and active components.

Typically, this integration may be accomplished using separate fiber interfaces, and fusing the fibers together. This results in a mass of interconnections and a degree of complexity which is much less desirable than the use of planar light circuits. This is because planar light circuits effectively integrate the components using well known semiconductor fabrication technology.

Thus, there is a need for better ways to utilize both thin film filters and planar light circuits.

### BRIEF DESCRIPTION OF THE DRAWINGS

FIG. 1 is a perspective view of one embodiment of the present invention;

FIG. 2 is a cross-sectional view taken generally along the line 2-2 in FIG. 1 with a photodetector 34 not shown in FIG. 1;

FIG. 3 is a cross-sectional view taken generally along the line 2-2 in FIG. 1 in an embodiment with a 45 degree mirror and photodetector not shown in FIG. 1;

FIG. 4 is an enlarged, cross-sectional view of another embodiment of the present invention; and

FIG. 5 is a top plan view of the embodiment shown in FIG. 4.

### DETAILED DESCRIPTION

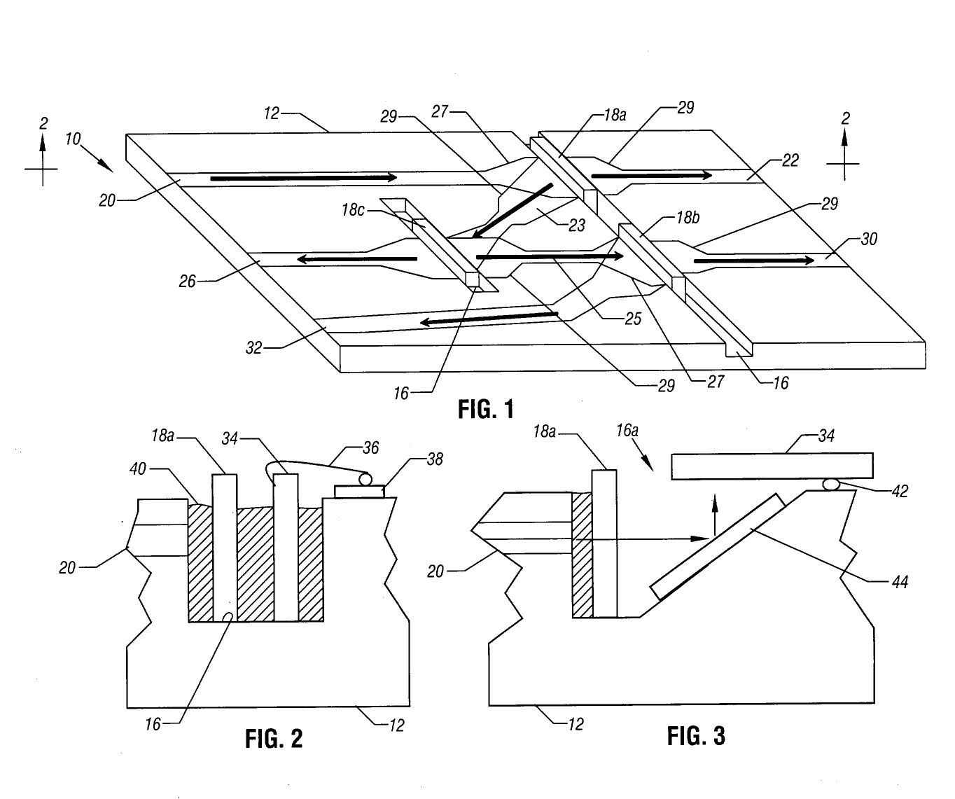

Referring to FIG. 1, a plurality of thin film filters 18 may be integrated into a planar light circuit 10. The planar light circuit 10 may be substantially formed on a semiconductor substrate 12 using conventional semiconductor processing technology. A slot, trench, or groove 16 may be formed in the substrate 12 and the filters 18a and 18b, for example, may be inserted therein in one embodiment of the present invention. In addition, another groove 16 may house a thin film filter 18c.

A light path 20 may be formed in the light circuit 12 to access the thin film filter 18a. A light path 22 may be provided for the light transmitted by the filter 18a, and a corresponding light path 23 may be provided for light reflected by the filter 18a. Similarly, a light path 26 may be provided for light transmitted by the thin film filter 18c and a light path 25 may be provided for reflected light from the filter 18c. Likewise, transmitted light through the filter 18b may be transmitted through the light path 30 and light reflected by the thin film filter 18b may be conveyed by the light path 32. In one embodiment, the light paths may be formed from a waveguide such as a clad core waveguide.

In one embodiment, a demultiplexer and multiplexer may be integrated by the light circuit 12. Light signals in the path 20 may have different wavelengths. When those light signals interact with the first thin film filter 18a, one wavelength may be transmitted along the path 22 while other wavelengths may be reflected along the path 23.

Referring to FIG. 2, the thin film filter 18a may be provided in a groove 16. The groove 16 may be filled with an index matching material 40, such as epoxy, in one embodiment of the present invention, to reduce Fresnel reflection losses. As examples, the groove 16 may be formed by etching or wafer dicing. A photodetector 34, formed in the groove 16, may be coupled to an electrical pad 38 through a wire bond 36 in one embodiment of the present invention.

The light reflected from the thin film filter 18a is guided over the path 23 to the second thin film filter 18c. The second thin film filter 18c passes a different wavelength through the path 26 and reflects other wavelengths over the path 25. The third thin film filter 18b then separates two remaining wavelengths, transmitting one wavelength over the path 30 and reflecting the other wavelength over the path 32.

Thus, a demultiplexing function may be achieved by a series of thin film filters 18. Advantageously, the light paths 20, 22, 23, 25, 26, 30, and 32 may be arranged so that they obey the reflection law, such that light can be collected.

To reduce the loss generated by the groove 16, the light paths may be tapered, both horizontally and vertically, as they go into and away from a thin film filter 18. This tapering expands the wavelength mode and increases the Rayleigh length. Inwardly tapering waveguide portions are indicated at 29 and outwardly tapering waveguide portions are indicated at 27.

For a coarse wavelength division multiplexed transceiver, photoreceivers with an active area much larger than the waveguide core size may be placed immediately after the thin film filters 18 so that the groove 16 width will not be in the planar light circuit path to give excess losses. The photoreceivers 34 can be placed either vertically into the groove 16, as shown in FIG. 2, or horizontally on top of the substrate 12, as shown in FIG. 3. The photoreceiver 34 may be wire bonded by a wire 36 to a bumped pad 38 in one embodiment.

As shown in FIG. 3, a 45 degree mirror 44 may be manufactured by etching a 45 degree slope on the slot 16a sidewall and depositing a reflective metal as a mirror 44. A variety of other devices may also be formed using hybrid technology including interleavers.

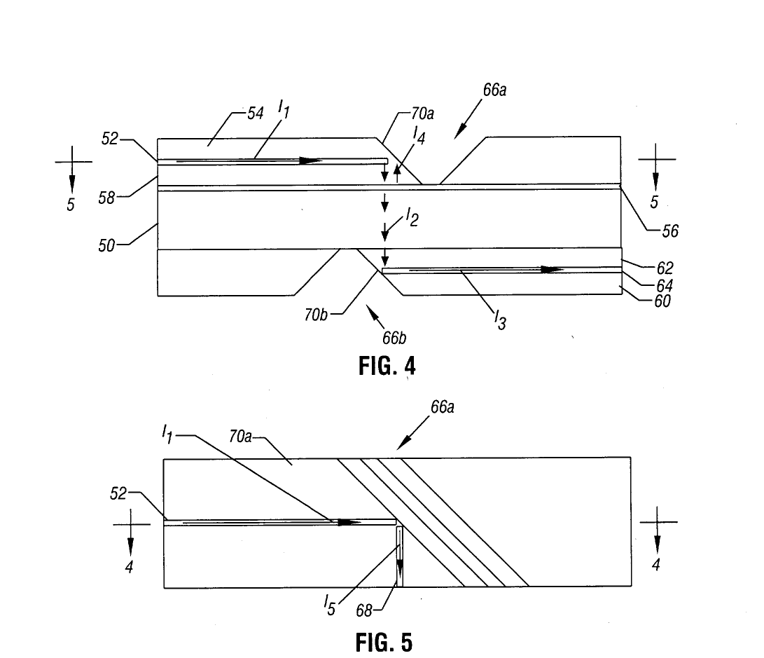

Referring to FIG. 4, in accordance with another embodiment of the present invention, a planar light circuit substrate 50 may have a thin film filter 56 formed on one or both opposed upper and lower sides thereof. An upper waveguide includes a core 52, upper cladding 54, and lower cladding 58. An angled groove 66a is formed through the upper waveguide. In one embodiment, the groove 66a may be V-shaped with a blunt end abutting the thin film filter 56. A sidewall 70a of the groove 66a is angled with respect to the core 52. The sidewalls of a groove 66 may be straight walls or may be curved to better focus the reflected light.

A light signal I₁, progressing along the core 52, is reflected by the sidewall 70a downwardly through the lower cladding 58, the thin film filter 56, and the relatively transparent substrate 50, as indicated at I₂. Thus, in one embodiment, the sidewall 70 is oriented at a 45 degree angle to the core 52 so that the incident light or the groove 66a is reflected downwardly.

The downwardly reflected light signal I₂ passes through a lower waveguide including an upper cladding 62 and a core 64. The lower waveguide may also include a lower cladding 60. The lower waveguide includes a lower groove 66b which may be complementarily shaped to the groove 66a. As a result, the light signal I₂ impacts the groove sidewall 70b, which is oriented, in one embodiment, at an angle of 45 degrees thereto. As a result, the light signal I₂ is redirected in a horizontal direction through the core 64, forming the light signal I₃.

The light signal I₂ is transmitted by the filter 56 because its wavelength corresponds to the pass wavelength of the filter 56. The light signal I₄ of a different wavelength is reflected by the thin film filter 56.

Referring to FIGS. 4 and 5, the signal I₄ extends upwardly through the lower cladding 58 to again impact the surface 70a. Since the signal I₄ is extending vertically rather than horizontally, as was the case of the signal I₁, the signal I₄ is reflected horizontally and transversely to the signal I₁ because the surface 70a is oriented at 45 degrees as indicated in FIG. 5. Thus, the groove 66a has 45 degree tapered sidewalls including the sidewall 70a, it is also oriented at 45 degrees to the directions of propagation of both the signal I₁ and the signal I₄. The signal I₄ may be reflected to form the signal I₅, which proceeds transversely away from the signals I₁, I₂, and I₄ over a core 68, thus separating the input light from the reflected light.

The combination of planar light circuit technology with thin film filter technology may achieve the best features of both technologies. The integration capabilities of planar light circuits may result in improved single channel filtering of thin film filters in some embodiments. In some embodiments, high performance thin film filter devices may be integrated with the highly integratable planar light circuits, especially for low channel count applications.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
forming a thin film filter in a planar light circuit; and
providing light paths in said planar light circuit for light reflected from and transmitted by said thin film filter.

2. The method of claim 1 including forming a groove in said planar light circuit and mounting said thin film filter in said groove.

3. The method of claim 1 including providing light paths having tapered sections adjacent said thin film filter.

4. The method of claim 1 including providing a plurality of thin film filters and light paths and conveying light from one thin film filter to another.

5. The method of claim 1 including forming a demultiplexer.

6. The method of claim 2 including mounting said thin film filter in an index matching material in said groove.

7. The method of claim 2 including mounting a photodetector in said groove.

8. The method of claim 2 including forming said groove with an angled wall.

9. The method of claim 8 including forming a reflector on said wall and arranging a photodetector over said reflector to receive light reflected by said reflector.

10. The method of claim 1 including forming a waveguide over said thin film filter.

11. The method of claim 10 including forming a groove with angled walls so as to reflect light in said waveguide downwardly through said filter.

12. The method of claim 11 including forming waveguides on opposite sides of a substrate.

13. The method of claim 12 including forming angled wall first and second grooves on each of said sides of said substrate to reflect light at approximately 90 degrees.

14. The method of claim 13 including angling said first groove at 45 degrees to a first waveguide to reflect light downwardly through said substrate to a second light path in a second waveguide on the opposite side of said substrate.

15. The method of claim 14 including forming the second groove in the second waveguide on the opposite side of said substrate and reflecting light from said first waveguide through said substrate through said second waveguide.

16. The method of claim 12 including receiving upwardly reflected light from said thin film filter and reflecting said light from said first groove.

17. The method of claim 16 including reflecting light directed upwardly in a direction transverse to the orientation of said first waveguide but extending in substantially the same plane as said first waveguide.

18. An optical device comprising:
a planar light circuit;
a thin film filter formed in said planar light circuit; and
a light path in said planar light circuit for a light reflected from and transmitted by said thin film filter.

19. The device of claim 18 including a groove in said planar light circuit, said thin film filter mounted in said groove.

20. The device of claim 18 including a plurality of filters formed in said planar light circuit and optical paths connecting at least two of said filters over said planar light circuit.

21. The device of claim 20 wherein each of said optical paths includes tapered portions proximate to said filters.

22. The device of claim 18 wherein said device is a demultiplexer.

23. The device of claim 19 including an index matching material in said groove.

24. The device of claim 19 wherein said groove includes an angled wall.

25. The device of claim 24 including a reflector on said angled wall.

26. The device of claim 18 including a waveguide over said thin film filter.

27. The device of claim 26 including a substrate and a waveguide on either side of said substrate.

28. The device of claim 27 including a groove formed in each of said waveguides.

29. The device of claim 28 wherein at least one of said grooves has tapered sidewalls.

30. The device of claim 29 wherein said groove is oriented at about 45 degrees to a core formed in said first waveguide.

31. The device of claim 30 including a light path extending through said first waveguide and said substrate to said second waveguide.

32. The device of claim 31 wherein said groove is arranged so that light reflected upwardly from said thin film filter is reflected at an angle of 90 degrees to said core.

33. An optical device comprising:
a planar light circuit;
a groove formed in said planar light circuit;
a first thin film filter formed in said groove; and
a first light path extending through said planar light circuit to said first thin film filter, a second light path extending on the opposite side of said first thin film filter away from said first thin film filter and a third light path extending away from said first thin film filter on the same side of said first thin film filter as said first light path.

34. The device of claim 33 including a pair of grooves formed in said planar light circuit and at least two thin film filters.

35. The device of claim 34 including a first light path to a first thin film filter, a second light path for light transmitted by said first thin film filter, a third light path for light reflected from said first thin film filter, a fourth light path for light transmitted by said second thin film filter, and a fifth light path for light reflected from said second thin film filter.

36. The device of claim 35 wherein each of said thin film filters transmits one light wavelength and reflects at least one other wavelength.

37. An optical device comprising:
a substrate;
a first waveguide formed on one side of said substrate;
a second waveguide formed on the opposite side of said substrate;
a reflective groove formed in said first and second waveguides; and
a thin film filter on said substrate.

38. The device of claim 38 wherein said substrate is substantially light transparent.

39. The device of claim 39 including a core in said first waveguide that transmits light to said first groove, such that said light is reflected downwardly through said substrate.

40. The device of claim 39 wherein said light reflected downwardly through said substrate is reflected by said second groove in said second waveguide so as to be transmitted by a core formed in said second waveguide.

41. The device of claim 40 wherein said downwardly reflected light passes through said filter if it is of the appropriate wavelength and is reflected by said thin film filter otherwise.
